(19) United States
(12) Patent Application Publication
(10) Pub. No.: US 2025/0268268 A1
(43) Pub. Date: Aug. 28, 2025

(54) HIGH VOLUME SCORING SYSTEM FOR BREAD DOUGH

(71) Applicant: T&T CONSULTING AND ENGINEERING, INC., East Dundee, IL (US)

(72) Inventors: Tomas TASSY, SR., East Dundee, IL (US); Antal SUTO, East Dundee, IL (US)

(21) Appl. No.: 19/060,205

(22) Filed: Feb. 21, 2025

Related U.S. Application Data
(60) Provisional application No. 63/556,629, filed on Feb. 22, 2024.

(51) Int. Cl. A21C 11/12; A21C 9/08

(52) U.S. Cl. CPC A21C 11/12; A21C 9/08

(57) ABSTRACT

A high volume scoring system for bread dough is provided with a conveyor table that includes a first scoring apparatus and a second scoring apparatus that is located downstream from the first scoring apparatus to permit longitudinal and angled scoring of dough pieces. Trays containing unbaked dough pieces are loaded onto the conveyor and shuttled downstream along the conveyor to selectively align the trays beneath the first or second scoring apparatus depending on whether diagonal or longitudinal score lines are desired on the dough pieces. The first scoring apparatus is configured to make a series of diagonal score lines on the dough pieces positioned beneath the first scoring apparatus using a first series of blades. The system can also convey the trays containing the unbaked dough pieces downstream along the conveyor to align the trays beneath the second scoring apparatus. The second scoring apparatus is configured to make longitudinal score lines on the dough pieces positioned beneath the second scoring apparatus using a second series of blades. Once the dough pieces have been scored, they are conveyed by the system into an oven for baking.

### PRIORITY CLAIM

This application claims priority under 35 U.S.C. § 119(e) to U.S. Provisional Application Ser. No. 63/556,629 filed Feb. 22, 2024, which is expressly incorporated herein by reference in its entirety.

### FIELD OF THE DISCLOSURE

The present disclosure relates generally to baking equipment, and more specifically to baking equipment used in the commercial baking industry.

### BACKGROUND

The baking industry, specifically the commercial baking industry, produces numerous baked goods such as loaves of bread, hamburger buns, hot dog buns, pizza crust, and pita bread, among other items. Several steps need to be performed to bread dough during preparation. Bread scoring of proofed dough pieces is the final step prior to baking certain bread products. Scoring creates an incision on the skin/surface of the dough, and can have a direct impact on overall appearance of the bread loaf. In small scale production, this process is typically done manually with sharp metallic blades (lames in French), while water jets are typically used in large scale scoring operations. Manual scoring adds unnecessary time, cost, and complexity to the baked process and is too slow for large scale operations. Use of water jets requires a high pressure water source and is highly complex and costly to implement. There is a need for a high volume scoring system for bread dough that will allow for the desired scoring of dough pieces without slowing down the overall commercial baking process to reduce the overall cost of the scored baked goods.

### SUMMARY

The present disclosure may comprise one or more of the following features and combinations thereof.

In illustrative embodiments, the present disclosure is directed to a high volume scoring system for bread dough. The scoring system a conveyor table that includes a first scoring apparatus and a second scoring apparatus that is located downstream from the first scoring apparatus. The present arrangement allows for both longitudinal and angled scoring of the dough pieces.

In illustrative embodiments, trays containing unbaked dough pieces are loaded onto the conveyor and shuttled downstream along the conveyor to align the trays beneath the first scoring apparatus. The first scoring apparatus is configured to make a series of diagonal score lines on the dough pieces positioned beneath the first scoring apparatus.

In illustrative embodiments, the conveyor can also convey the trays containing the unbaked dough pieces downstream along the conveyor to align the trays beneath the second scoring apparatus. The second scoring apparatus is configured to make longitudinal score lines on the dough pieces positioned beneath the second scoring apparatus. Once the dough pieces have been scored, they are conveyed into an oven for baking.

These and other features of the present disclosure will become more apparent from the following description of the illustrative embodiments.

### BRIEF DESCRIPTION OF THE DRAWINGS

FIG. 1 is a perspective view of a high volume scoring system of the present disclosure showing a linear conveyor for conveying trays of unbaked dough pieces, a first scoring apparatus and a second scoring apparatus positioned downstream from the first scoring apparatus;

FIGS. 2-7 illustrate the first scoring apparatus;

FIG. 2 is a perspective view of the first scoring apparatus fully assembled;

FIG. 3 is a side elevational view of the first scoring apparatus of FIG. 2 showing a series of serrated blades used to score dough pieces positioned beneath the blades;

FIG. 4 is a perspective view of the first scoring apparatus with a top plate removed showing the middle plate and the bottom plate and also showing the diagonal slide rails;

FIG. 5 is a perspective view of the first scoring apparatus with the top plate and middle plate removed and showing the bottom plate and showing the transverse slide rails that are transverse to the direction of movement of the trays on the conveyor;

FIG. 6 is a perspective view of the first scoring apparatus with the top, middle and bottom plates removed and showing the plurality of blades mounted in blade holders that are in three unit blocks;

FIG. 7 is a close up perspective view of FIG. 6 showing the blades passing through a blade cleaner plate that removes unwanted dough from the blades;

FIG. 8 is a perspective view of the second scoring apparatus showing the apparatus inside of a safety enclosure and secured to the linear conveyor;

FIG. 9 is a perspective view of the overhead shuttle of the second scoring apparatus and also showing the blade wiper assembly in front of the blades;

FIG. 10 is a side perspective view of the second scoring apparatus showing the scoring blade assembly secured to a linear actuator used to raise and lower the blades and also showing the blade wiper assembly;

FIG. 11 is another perspective view of the wiper assembly and the blade assembly;

FIG. 12 is another perspective view of the wiper assembly with one of the wiper blocks removed to show the position of the blade;

FIG. 13 is a top view of the second scoring apparatus showing a tray of dough pieces positioned below the second scoring apparatus and showing the dough pieces each including a longitudinal slit added to the dough pieces by the blades;

FIG. 14 is another perspective view of the second scoring apparatus showing one of the wiper blocks 108 removed from a wiper bar used to secure the wiper blocks;

FIG. 15 is a perspective view of the conveyor used to convey the trays of dough pieces beneath the first and second scoring apparatuses;

FIG. 16 is a side elevational view of the conveyor showing the linear cylinder used to covey a shuttle along a frame of the conveyor;

FIG. 17 is an end view of the conveyor;

FIG. 18 a second side elevation of the conveyor;

FIG. 19 is a top view of the conveyor;

FIG. 20 is a perspective view of the conveyor with portions removed to show the shuttle that is moved linearly along the frame by the linear cylinder;

FIG. 21 is a perspective view of a pusher component of the conveyor;

FIG. 22 is a perspective view of an alternative embodiment of the blade arrangement used in the first scoring apparatus showing the plurality of razor blades mounted in blade holders secured to a support bar;

FIG. 23 is a side elevational view of the second scoring apparatus showing the alternate embodiment of the blade assembly showing a blade holder coupled to a blade bar wherein the blade holder is holding a razor blade;

FIG. 24 is a perspective view of the blade assembly of FIG. 23 showing a razor blade secured into a blade holder and blade arm; and

FIG. 25 is a perspective view of the first scoring apparatus showing the alternative embodiment of the diagonal cut blade assembly having a series of blades secured to blade holders and used to cut diagonal score lines on the dough pieces.

### DETAILED DESCRIPTION

For the purposes of promoting an understanding of the principles of the disclosure, reference will now be made to a number of illustrative embodiments illustrated in the drawings and specific language will be used to describe the same.

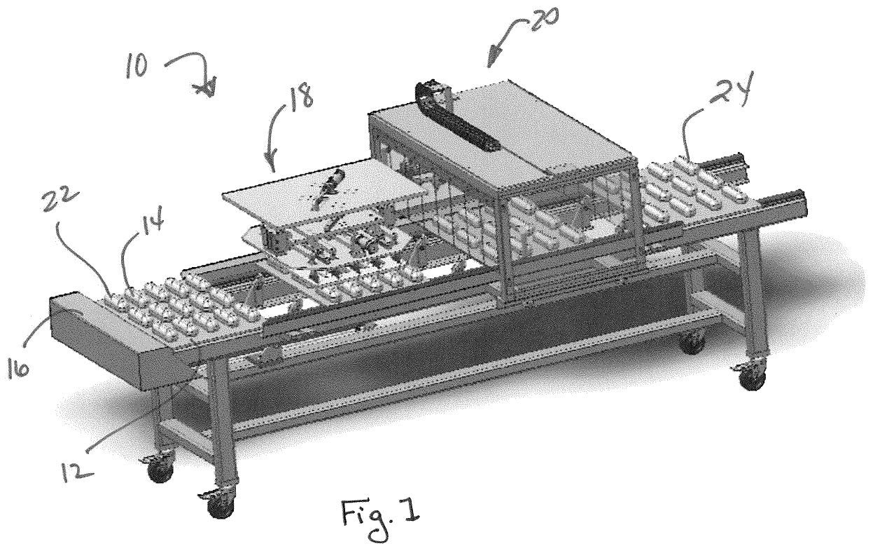

A high volume scoring system 10 for scoring bread dough pieces 14 is shown in FIG. 1. The high volume scoring system 10 is part of a commercial baking process and is a portable unit that can be added to any baking line. The scoring system 10 is integrated into a commercial baking process that includes a tunnel oven (not shown) located downstream from the high volume scoring system 10. Rows of baking trays 12 containing individual dough pieces 14 are placed on a linear conveyor 16, which forms part of the scoring system 10. Linear conveyor 16 is configured to convey the baking trays 12 to either a first scoring apparatus 18 or a second scoring apparatus 20, which can be positioned either upstream or downstream from the first scoring apparatus 18. The first scoring apparatus 18 is configured to place diagonal score lines 22 across the dough pieces 14. The second scoring apparatus 20 is configured to place longitudinal score lines 24 along the length of the dough pieces 14. First and second scoring apparatuses 18, 20 can either be fixed in position relative to conveyor 16 or, for higher speed installations, can be configured to shuttle along the conveyor 16 with the movement of the trays 12 to score dough pieces 14 as they are moving along conveyor 16.

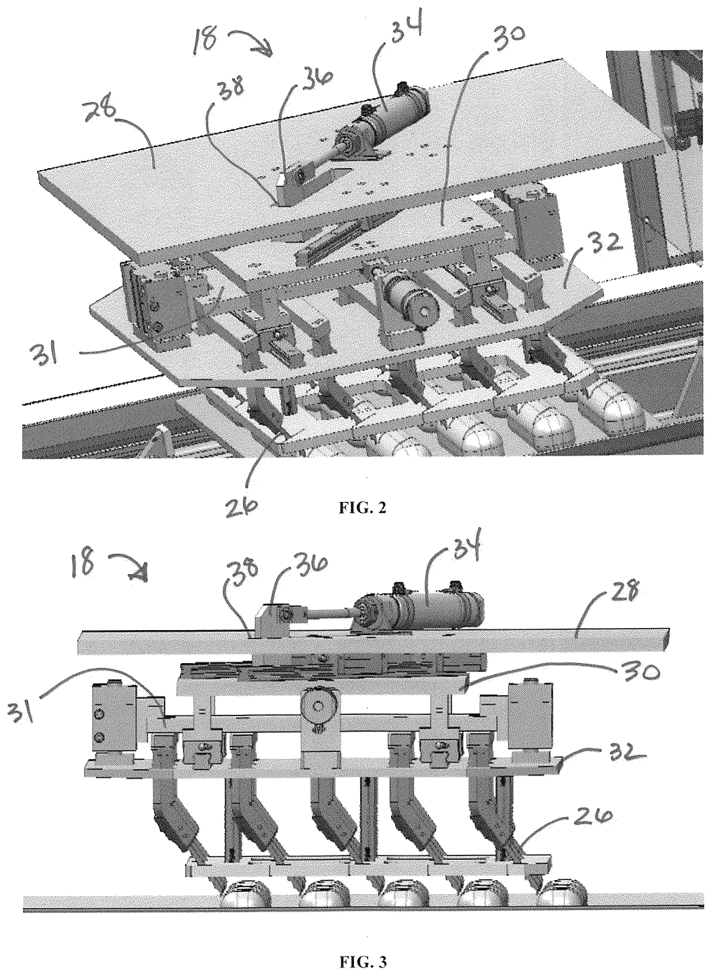

First scoring apparatus 18 of high volume scoring system 10 is positioned downstream from the start of conveyor 16 and has the capability to score fifteen or more dough pieces 14 sequentially. While fifteen dough pieces are shown, the first scoring apparatus 18 can sequentially score any number of dough pieces 14 as desired. First scoring apparatus 18 includes a series of serrated blades 26 that extend downwardly at an angle to horizontal, as shown in FIGS. 2 & 3. Blades 26 are configured to move along three axes of movement to properly score the dough pieces 14.

First scoring apparatus 18 of high volume scoring system 10, from top to bottom, includes a top plate 28, a spaced apart middle plate 30, a cross plate 31, and a spaced apart lower plate 32, as shown in FIGS. 2 and 3. While top plate 28, middle plate 30, cross plate 31, and lower plate 32 are described as plates, any other support structures or members can be used.

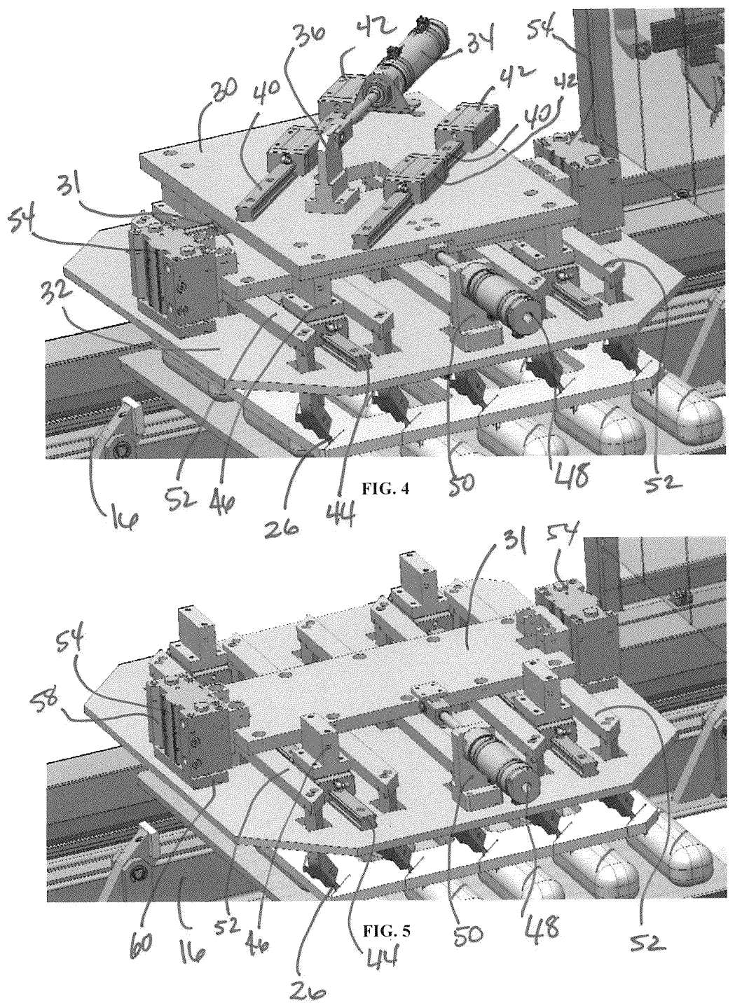

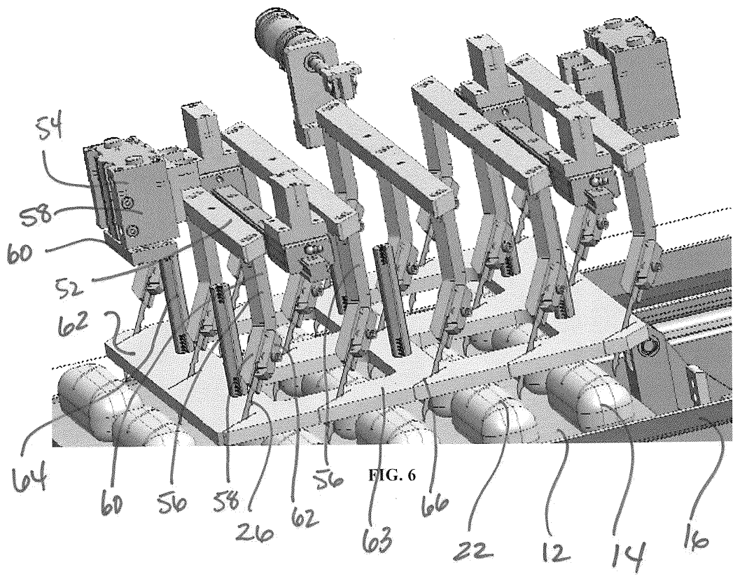

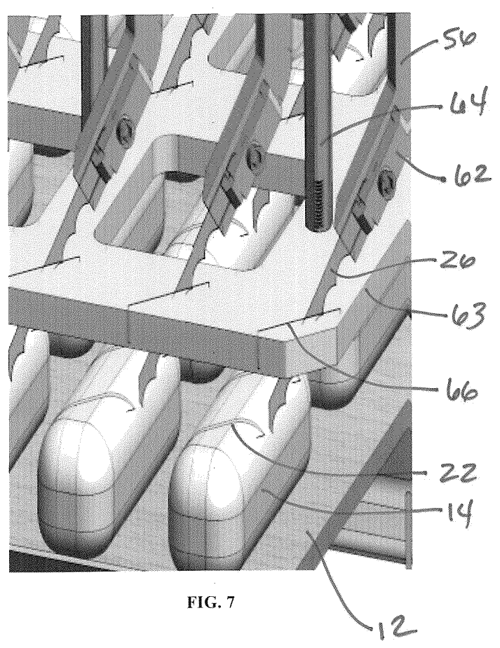

The top plate 28 of high volume scoring system 10 includes a linearly actuated first cylinder 34 that is secured to top plate 28 and includes a bracket 36 that extends through a slot 38 formed in the top plate 28, as shown in FIGS. 2 and 3. Top plate 28 is generally fixed in position. Bracket 36 is secured to middle plate 30 and is configured to move middle plate 30 along a first set of rail supports 42 by use of rails 40, as shown in FIG. 4. Actuation of first cylinder 34 causes movement of the middle plate 30, cross plate 31, bottom plate 32, and the blades 26, forty five (45) degrees to the direction of movement of trays along conveyor 16 to apply a diagonal score lines on dough pieces 14. Rails 40 are slidably coupled to rail supports 42. Rail supports 42 are secured to top plate 28 by use of fasteners. While the rails 40 are preferably oriented at 45 degrees to the direction of the conveyor 16, it is contemplated that rails can be oriented at other desired angles from about 25 degrees to about 60 degrees, for example. Middle plate 30 is connected to lower rail supports 44 located proximate the bottom plate 32 by use of connectors 46.

Cross plate 31 of high volume scoring system 10 is positioned below middle plate 30 and is used to move blades 26 in a linear direction that is perpendicular to the direction of the trays 12 along the conveyor 16. Linear movement of the blades 26 is necessary when more than one diagonal score line is required on the dough pieces 14. Once the first diagonal score line is cut, blades 26 are moved perpendicularly to the length of the conveyor so that an additional diagonal score line can be added to the dough pieces 14. Cross plate 31 is moved by a second cylinder 48 in a linear direction that is perpendicular to the movement of the conveyor 16. In other words, the second cylinder 48 moves the cross plate 31 transversely to the direction of the conveyor 16. Second cylinder 48 is secured to bottom plate 32 by use of bracket 50.

Cross plate 31 of high volume scoring system 10 is also coupled to a series of transversely mounted blade bars 52, as shown in FIGS. 4 & 5. Blade bars 52 are spaced apart from each other and move together with cross plate 31 when second cylinder 48 is activated. Cross plate 31 also is coupled to a pair of linear actuators 54. Linear actuators 54 are coupled to each end of the cross plate 31 and are also coupled to the bottom plate 32. Linear actuators 54 are designed to vertically raise and lower the cross plate 31 and blades 26 vertically from a first elevation to a second elevation, which is higher than the first elevation. In the first elevation, the blades 26 are not in contact with the dough pieces 14. When in the second elevation, the blades 26 are in contact with the dough pieces 14 and the first cylinder 34 can be activated so that blades 26 can form diagonal score lines in dough pieces 14.

Blades 26 are secured to blade bars 52 by use of blade holders 56, as shown in FIG. 6. There is one blade holder 56 for each blade 26 used to score the dough pieces 14. Blade holders 56 include a lower leg 58 and an upper leg 60. Lower leg 58 include a clamp member 62 that is used to secure blade 26 to lower leg 58 of blade holder 56. This allows blades 26 to be replaced and/or adjusted as needed. The upper leg 60 of the blade holder 56 is configured to be secured to the blade bars 52 by use of fasteners. Lower leg 58 of blade holder 56 is shown as secured to upper leg 60 at an angle of about 45 degrees. While a fixed angle is shown, it is completed that lower leg 58 can be pivotally coupled to upper leg 60 so that any desired angle can be used, such a 25 degree or a 30 degree angle, for example.

In another embodiment, the blades 26 can be configured to each rotate about an axis of rotation. In this arrangement, the blade holders 56 would each include a bearing to allow the blades 26. In this arrangement, it would be preferred to use a thicker plate with 2 bearings for each cutting blade holder support. The blade holders would then be interconnected by use of a linkage assembly. A common rod would be used to connect the linkage assembly to an air cylinder, which would allow an operator to rotate the blades to allow for straight or diagonal cuts.

Linear actuators 54 are coupled to bottom plate 32 and to cross plate 31. Outer housing 58 is secured to cross plate 31 and inner member 60 is coupled to bottom plate 32. Outer housing 58 is designed to extend away from inner member 60 to elevate cross plate 31, blade bars 52 and blades 26. Linear actuators 54 move cross plate 31, blade bars 52, blade holders 56, and blades 26 in a vertical direction.

High volume scoring system 10 also include cleaner plate 63, as shown in FIGS. 6 & 7. Cleaner plate 63 is secured to bottom plate 32 by a series of posts 64. Cleaner plate 63 also includes a series of slits 66 formed in the cleaner plate 62. Slits 66 are sized to allow for the passage of blades 26. After the blades 26 slit the dough pieces 14, they are retracted upward so that cleaner plate 63 can remove any residual dough that may have clung to the blades 26 to, in effect, squeegee or wipe the blades of any dough residue. This arrangement limits the amount of maintenance that needs to be done to high volume scoring system 10.

In use, a baking tray 12 that include a series of dough pieces 14 is positioned by conveyor 16 beneath the first scoring apparatus 18. Once in position, linear actuators 54 lower blades 26 and first cylinder 34 moves blades 26 in a diagonal direction from a first position to a second position so that diagonal score lines are made on the dough pieces 14. Next, blades 26 are raised by linear actuators 54 and first cylinder 34 moves blades back from the second position back to the first position. Next, second cylinder 48 moves blades 26 transversely to the conveyor 16. Linear actuators 54 again lower the blades 26 and first cylinder 34 moves blades 26 in a diagonal direction from the first position to the second position so that second diagonal score lines are made in the dough pieces 14. After the second score lines are cut, linear actuators 54 raise blades 26, which are wiped clean as the blades 26 move through slits 66 in cleaning plate 62.

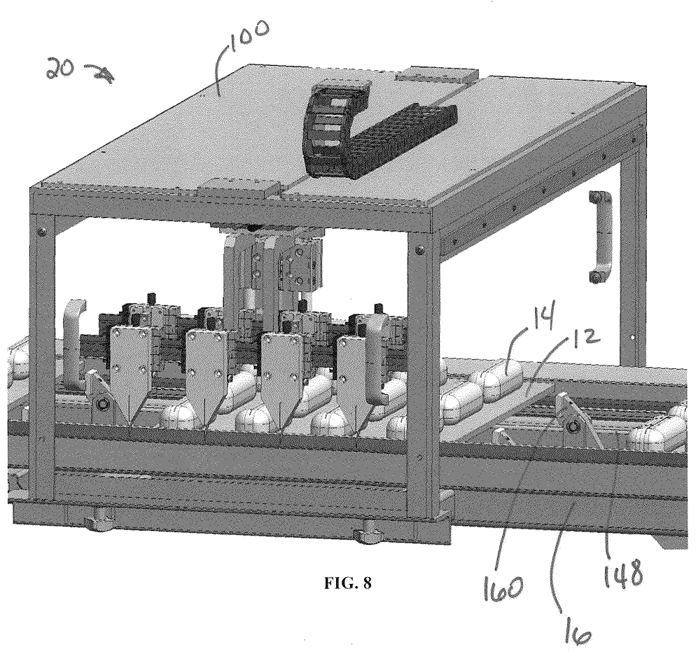

Second scoring apparatus 20, which is positioned downstream from first scoring apparatus 18 includes a housing 100 that is secure to conveyor 16, as shown in FIG. 8. Second scoring apparatus 20 is configures to place scoring lines onto a series of dough pieces 14 positioned on a tray 12 positioned beneath second scoring apparatus 20. Second scoring apparatus 20 is configured to score all of the dough pieces 14 sequentially and then self-clean blades 102 that are used for the scoring operation. Second scoring apparatus 20 includes an overhead track 104 that is arranged perpendicular to the direction of the conveyor 16 and a shuttle 106 that is configured to be moved along the track 104 by a pneumatic cylinder (not shown).

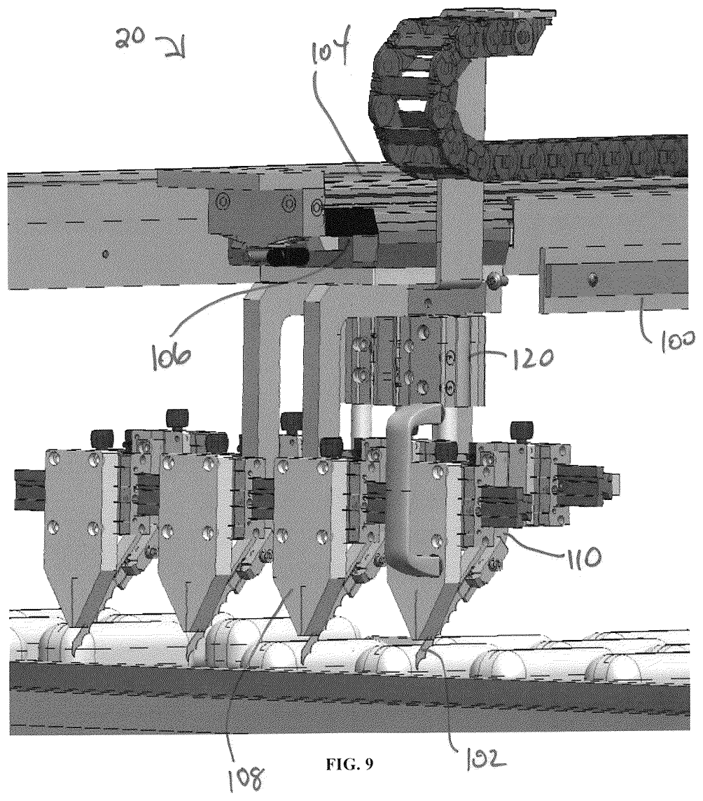

Second scoring apparatus 20 includes a row of serrated cutting blades 102 positioned behind a row of blade wiper blocks 108, as shown in FIG. 9. Blades 102 are each secured to individual blade holders 110. Blade holders 110 are each mounted onto a longitudinal blade bar 112. Blade holders 110 are independently adjustable along blade bar 112 and are locked into position with set screws 114. This arrangement allows the blade holders 110 and blades 102 to be independently adjustable with respect to one another and can be removed from the blade bar 112 altogether for servicing or to reduce the number of blades 102. In the present disclosure, four blades are shown to score dough pieces 14 on a tray 12. While four blades 102 are shown, three blades or five blades could also be used, for example.

Blade bar 112 is coupled to bracket 118, which, in turn, is coupled to a vertically oriented linear actuator 120, as shown in FIG. 9. Linear actuator 120 is coupled to an arm 122, which is secured to shuttle 106 to allow arm 122, linear actuator 120, bracket 118, blade bar 112 and blades 102 to move perpendicular to movement of conveyor 16 by movement of shuttle 106 along overhead track 104. Linear actuator 120 is configured to move bracket 118, blade bar 112, blade holders 110 and blades 102 vertically from a first position where the blades 102 are is position to score the dough pieces 14 and a second position where the blades 102 are elevated so they are no longer making contact with the dough pieces 14.

Arm 122 at its lower end includes a leg 124 that is provided with an adjustable stop 126. Adjustable stop 126 limits the downward movement of linear actuator 120 by making contact with bracket 118. This arrangement allows for the adjustment of the lowermost extent of blades 102. Blade holders 110 include blade retainers 128 that allow blades 102 to be removed and replaced as necessary. While blades 102 are secured by blade holder 110 at approximately 45 degrees, it is contemplated that other angles can be used and blade holder 110 can be made so that the angle can be adjusted by the user.

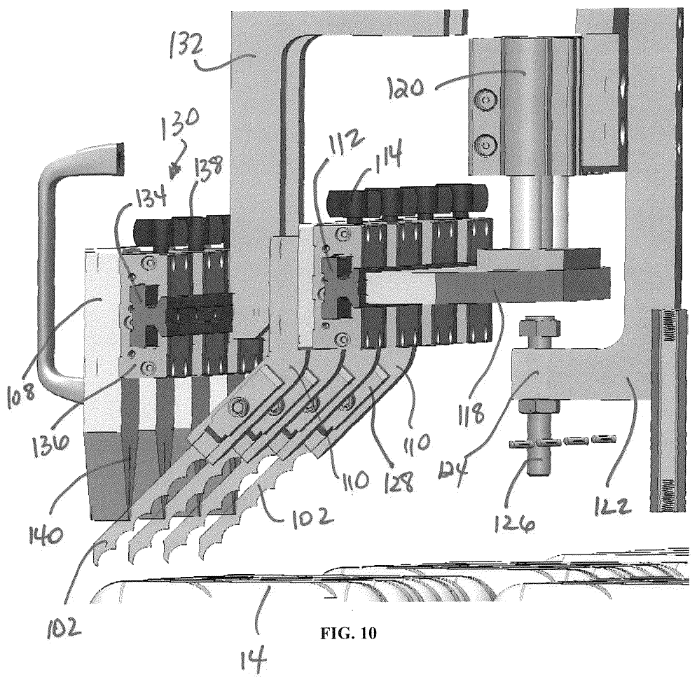

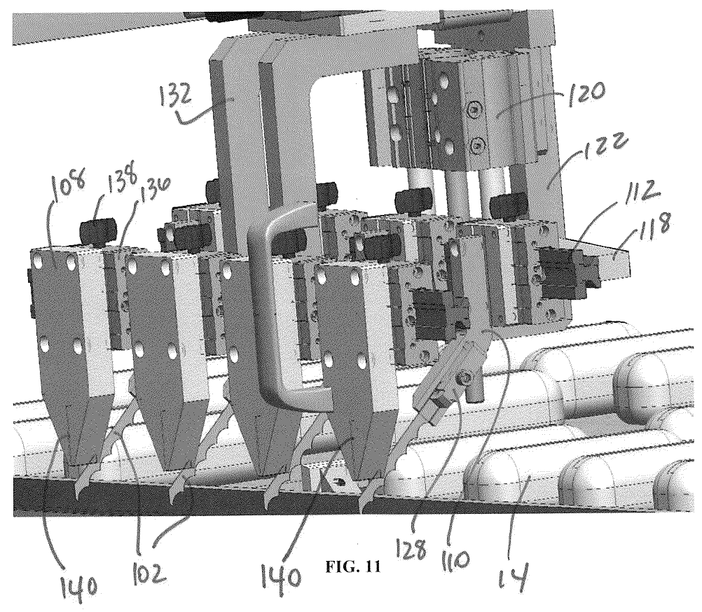

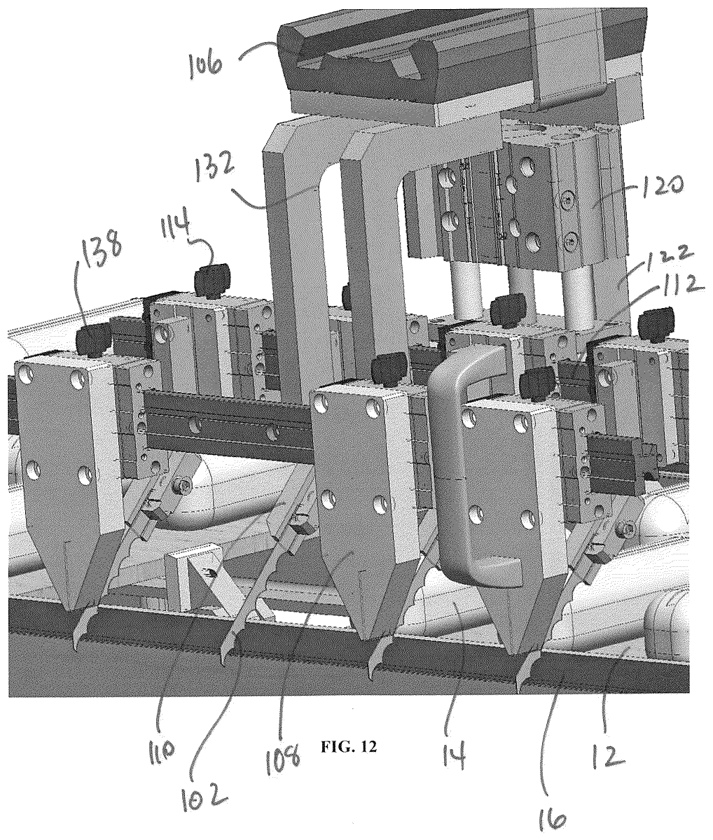

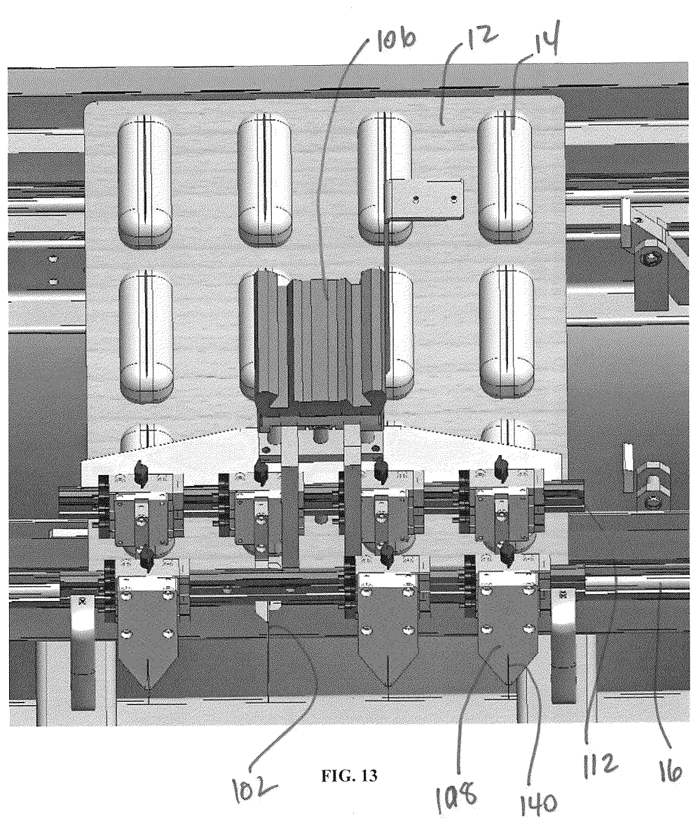

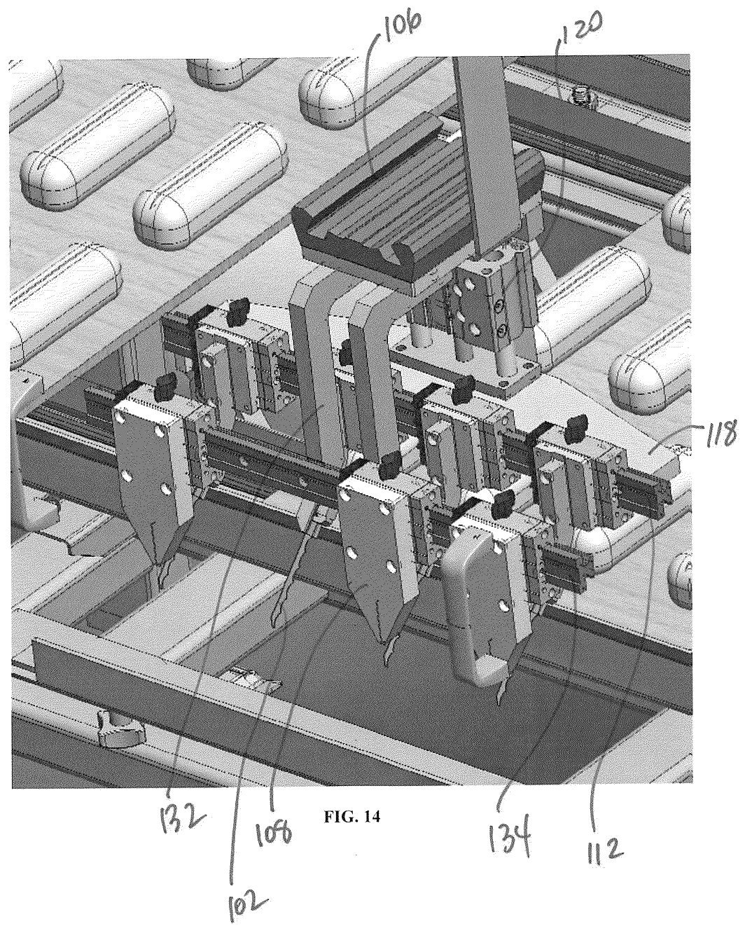

Second scoring apparatus 20 also includes a blade wiper assembly 130, as shown in FIG. 10. Blade wiper assembly 130 is configured to remove dough residual from blades 102 when retracted and moved upward away from dough pieces 14. Blade wiper assembly 130 includes a pair of arms 132 that have an upper end coupled to shuttle 106 and a lower end coupled to a wiper bar 134. Wiper bar 134 is horizontally oriented and is configured to accept adjustable brackets 136. Brackets 136 are configured to secure wiper blocks 108. Brackets 136 include adjustment thumb screws 138. Screws 138 allow the wiper blocks 108 to be repositioned along wiper bar 134 to align wiper blocks 108 with blades 102 and then locked into position. Wiper blocks 108 each include a slit 140 that is sized to allow for the passage of blades 102 to wipe off any excess dough from the scoring process. Once blades 102 are elevated, shuttle moves blades 102 and wiper blocks 108 back to one side of the conveyor 16 to await the next tray of dough pieces 14.

In use, linear actuator 120 starts with blades 102 in an elevated position and shuttle 106 moves blades 102 and blade wiper assembly 130 to one side of conveyor 16. A tray 12 of dough pieces 14 is conveyed beneath second scoring apparatus 20. Once the system has determined that the tray 12 is in the correct position, linear actuator 120 lowers the four blades 102, as illustrated in the figures. Once the blades 102 are lowered, shuttle 106 moves along overhead track 104 and blades score dough pieces 14 sequentially along the tray until all of the dough pieces 14 are scored. Once the dough pieces 14 are scored, linear actuator 120 raises blade 102, which are wiped off by wiper blocks 108 to remove any excess dough pieces 14. While second scoring apparatus 20 is shown as fixed in the drawings, it can shuttle along with the trays 12 so that the operation can be continuous without requiring the trays to stop for scoring.

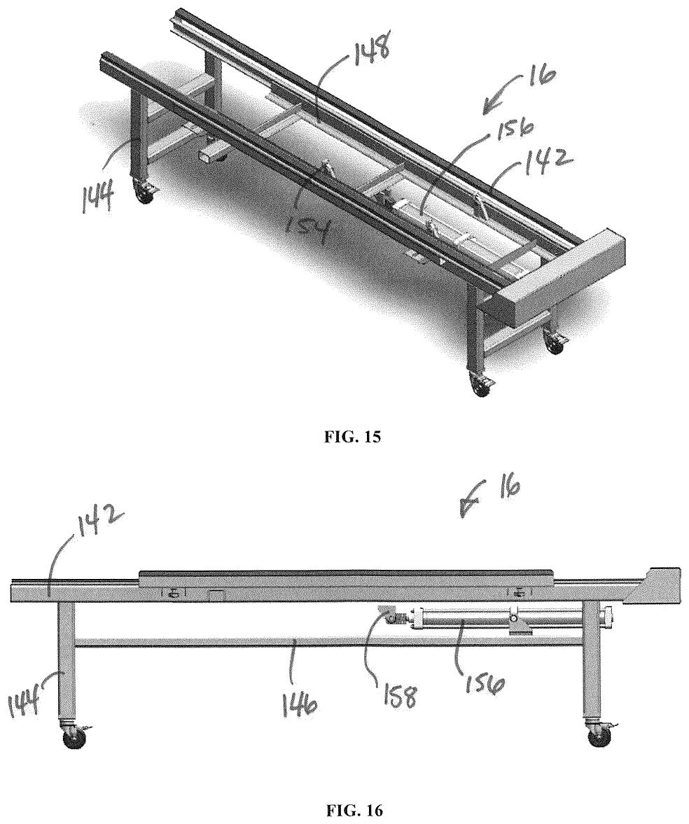

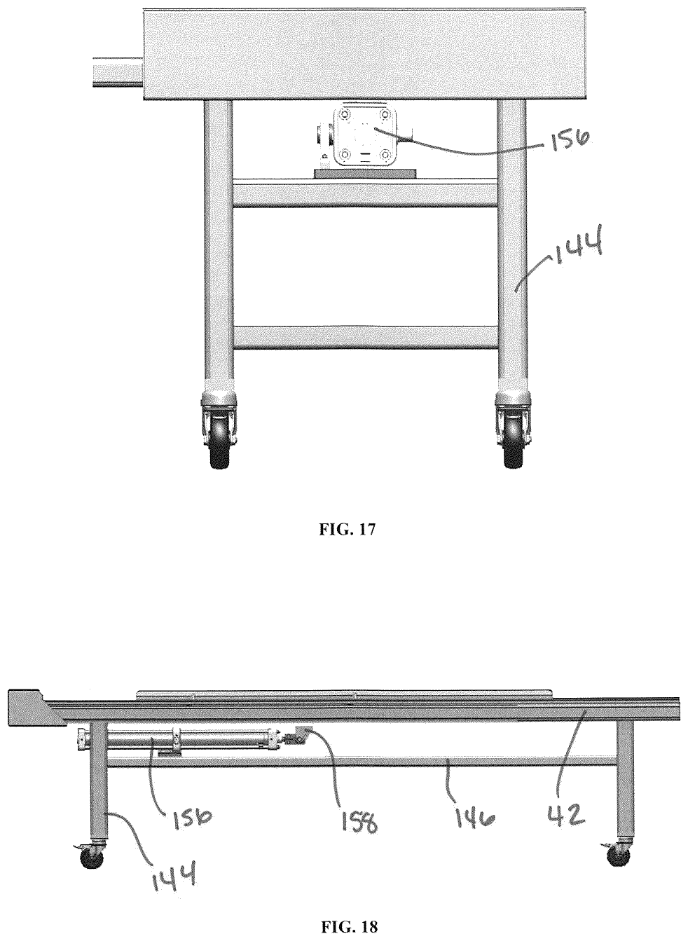

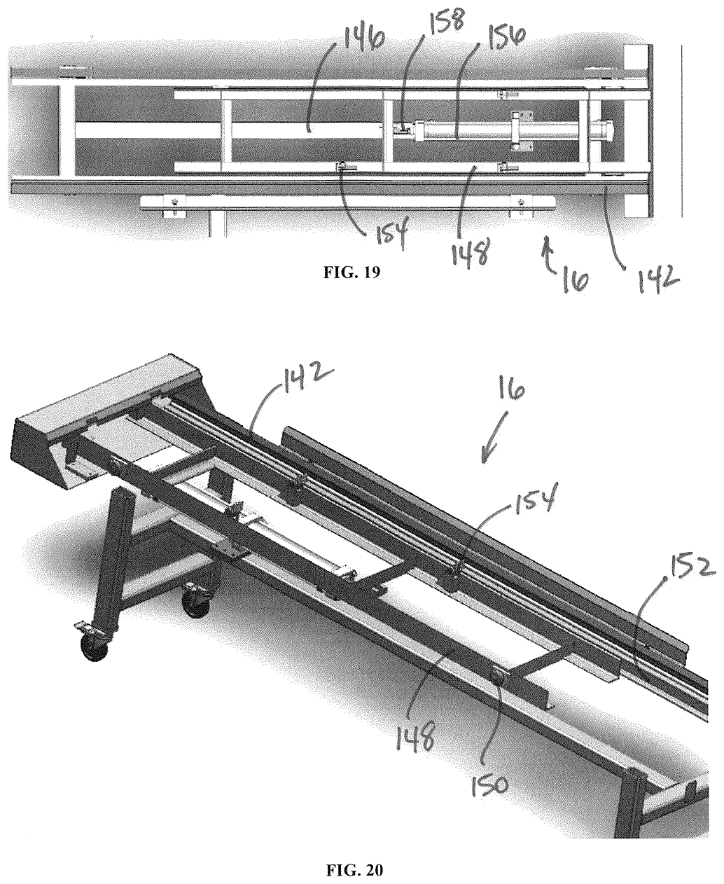

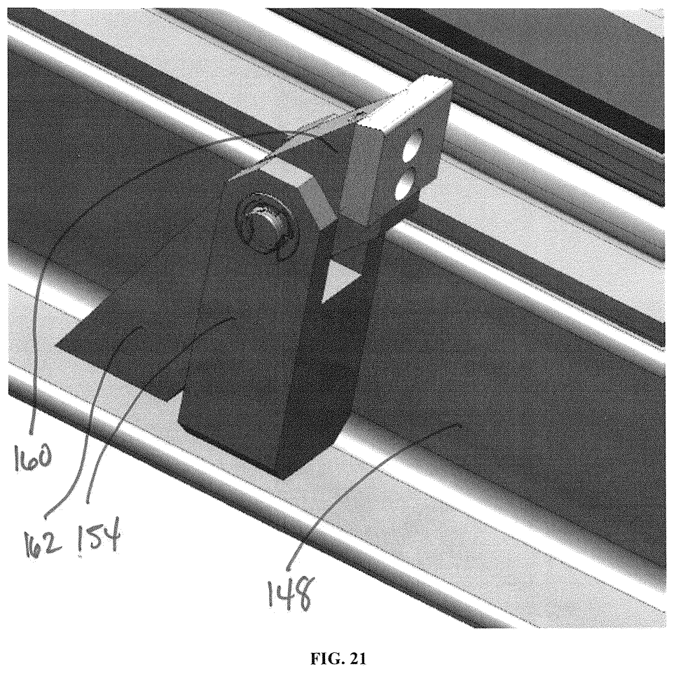

Conveyor 16 is an elongated structure used to convey trays 12 of dough pieces 14 under first and second scoring apparatuses 18, 20, as shown in FIGS. 15-21. Conveyor 16 includes frame rails 142 supported by legs 144. Leg sets are interconnected by longitudinal bar 146. Conveyor 16 also include a shuttle 148 that is slidably connected to frame rails 142 by a set of rollers 150. Rollers 150 are positioned within channels 152 formed in frame rails 142.

Shuttle 148 of conveyor 16 includes a set of pushers 154. Pushers 154 are used to push trays 12 along conveyor 16. Conveyor also include a linear actuator in the form of a pneumatic cylinder 156. Pneumatic cylinder 156 is coupled to longitudinal bar 146 and includes a bracket 158 that is connected to shuttle 148. Cylinder 156 is configured to move shuttle 148 along frame rails 142 when cylinder 156 is extended. Shuttle 148 uses pushers 154 to push trays 12 the entire length of frame rails 142 of conveyor 16 into an oven. Pushers 154 include a pawl 160 that is pivotally coupled to bracket 162. Pawl 160 is designed to engage trays 12 in a first down stream direction and pivot and go under upstream trays when moving in a second upstream direction.

In use, shuttle 148 of conveyor 16 is moved from an upstream position toward a downstream position by cylinder 156. Pawls 160 of pushers 154 engage and push trays along frame rails 142 to the first and second scoring apparatuses 18, 20 and then to an oven. Once the shuttle 148 reaches the end of its travel, cylinder 156 pulls shuttle 148 back upstream to engage new trays 12. As shuttle 148 moves upstream, pawls 160 pivot about brackets 162 to allow pawls 160 to pass beneath trays 12. Once past trays 12, pawls 160 return to their original operating position so that they can again push trays 12 downstream.

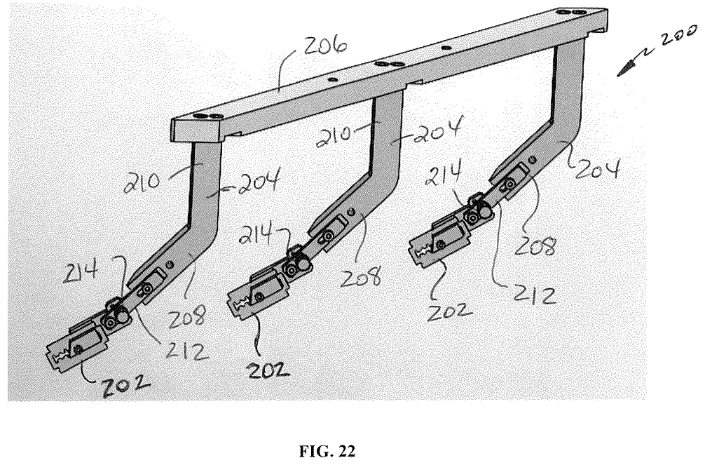

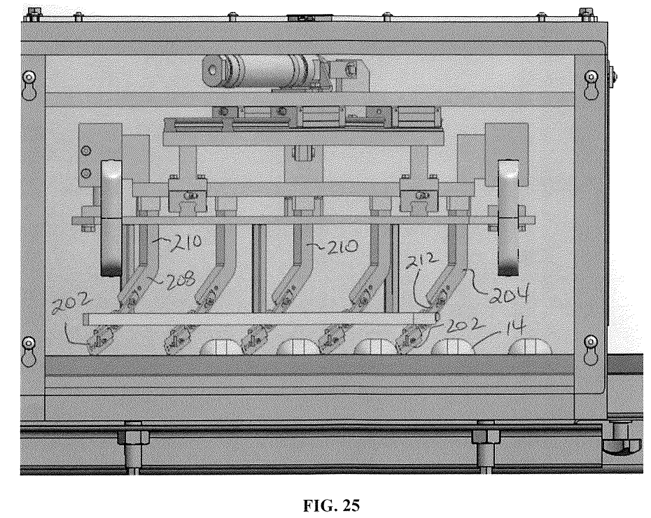

FIGS. 22 and 25 are perspective views of an alternative embodiment of the scoring blade arrangement 200 used with the first scoring apparatus 18. The scoring blade arrangement 200 uses razor blades 202 that are removably mounted in blade holders 204. Blades 202 are secured to blade bars 206 by use of the blade holders 204. There is one blade holder 204 for each blade 202 used to score the dough pieces 14. Blade holders 204 include a lower leg 208 and an upper leg 210. Lower leg 208 include a clamp member 212 that is used to secure blade 202 to lower leg 208 of blade holder 204. This allows blades 202 to be replaced and/or adjusted as needed. Clamp member 212 includes a pivot 214 that allows the angle of the blade 202 to be adjusted for alignment purposes so that the proper depth score line is formed. The upper leg 210 of the blade holder 204 is configured to be secured to the blade bars 52 by use of fasteners. Lower leg 208 of blade holder 204 is shown as secured to upper leg 210 at an angle of about 45 degrees. While a fixed angle is shown, it is completed that lower leg 208 can be pivotally coupled to upper leg 210 so that any desired angle can be used, such a 25 degree or a 30 degree angle, for example.

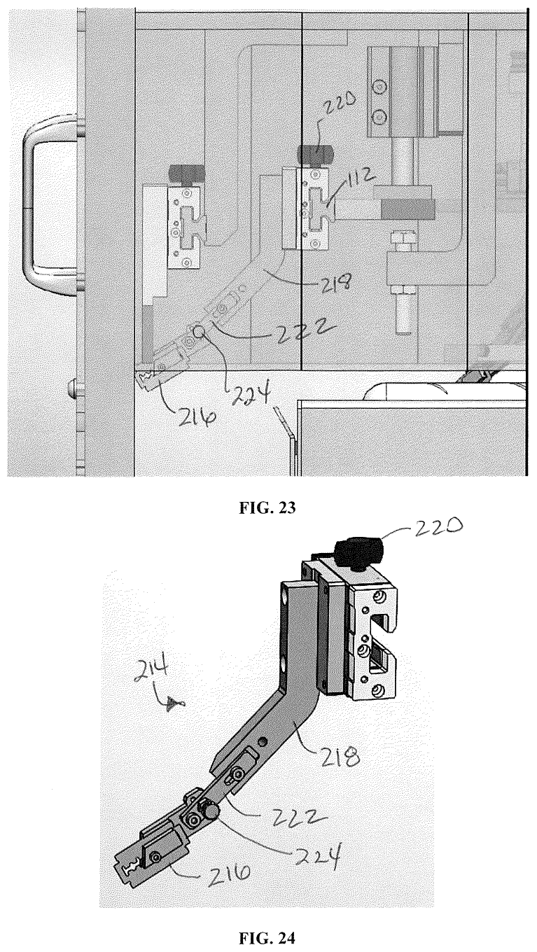

FIGS. 23 and 24 show an alternate embodiment of the scoring blade arrangement 214 for the second scoring apparatus 20. Second scoring apparatus 20 includes a row of replaceable razor scoring blades 216. Scoring blades 216 are each secured to individual blade holders 218. Blade holders 218 are each mounted onto a longitudinal blade bar 112. Blade holders 218 are independently adjustable along blade bar 112 and are locked into position with set screws 220. This arrangement allows the blade holders 218 and scoring blades 216 to be independently adjustable with respect to one another and can be removed from the blade bar 112 altogether for servicing or to reduce the number of scoring blades 216. In the present disclosure, four blades are shown to score dough pieces 14 on a tray 12. While four scoring blades 216 are shown, three blades or five blades could also be used, for example.

Blade holders 218 include blade retainers 222 that allow scoring blades 216 to be removed and replaced as necessary. While scoring blades 216 are secured by blade holder 218 at approximately 45 degrees, it is contemplated that other angles can be used and blade holder 218 can be made so that the angle can be adjusted by the user. Blade holders 218 include a pivot 224 that allows the angle of the scoring blades 216 to be changed with respect to the blade holders 218 for fine tuning.

The scoring device 10 is configured for scoring a series of dough pieces 14 arranged on a support surface, such as a tray 12, with at least one score line 22. The scoring device 10 includes a conveyor 16 is for conveying the dough pieces 14 in a longitudinal direction to a first scoring apparatus 18. The first scoring apparatus 18 is configured for scoring the dough pieces 14 on the baking trays 12. The first scoring apparatus 18 having a series of scoring blades 26. The first scoring apparatus 18 includes a first actuator 34 configured for moving the scoring blades 26 in a first direction from a first position to a second position, which is generally a vertical movement toward and away from the dough pieces 14.

The first scoring apparatus 18 includes a second actuator 48 configured for moving the scoring blades 26 in a second direction that is different from the first direction, which is generally diagonal to the direction of the conveyor 16. Movement of the scoring blades 26 in the second direction causes the scoring blades 26 to form at least one score line 22 on each of the dough pieces 14. The conveyor 16 is configured to convey the dough pieces 14 to the first scoring apparatus 18 for scoring and away from the first scoring apparatus 18 after the scoring of the dough pieces 14 is completed. The first scoring apparatus 18 also includes a blade wiper which can be in the form of a cleaner plate 66 that is configured to assist in wiping or cleaning dough from the blades after the scoring blades 26 score the dough pieces 14.

The blade wiper is in the form of a cleaner plate 66 formed to include a series of slits 66, wherein the blades are configured to move within the slits 66. The scoring device 10 uses the conveyor 16 to convey and align the dough pieces 14 with the scoring blades 26. The second actuator 48 is configured to move the scoring blades 26 in a direction that is diagonal to the longitudinal direction of the conveyor 16. Alternatively, the scoring device 10 can be arranged so that the second actuator 48 is configured to move the scoring blades 26 in a direction that is perpendicular to the longitudinal direction of the conveyor 16. The scoring blades 26 are generally arranged in a row and spaced apart from each other and are configured to move in unison when moved by the second actuator 48 to score the dough pieces 14.

The scoring blades 26 can be used to apply multiple score lines on the dough pieces 14 so that each dough piece include more than one score line. The scoring device 10 also includes a second scoring apparatus 20 positioned downstream from the first scoring apparatus 18. The second scoring apparatus 20 is configured for scoring the dough pieces 14. For example, the first scoring apparatus 18 can apply diagonal score lines while the second scoring apparatus 20 can apply a score line that is perpendicular to the direction of travel of the conveyor 16, for example. The second scoring apparatus 20 having a second series of scoring blades 102. the second scoring apparatus 20 includes a first actuator 120 configured for moving the second series of scoring blades 102 in a first direction from a first position to a second position. The second scoring apparatus 20 includes a second actuator or shuttle 106 is configured for moving the second series of scoring blades 102 in a second direction that is different from the first direction. Movement of the second series of scoring blades 102 in the second direction causes the second series of scoring blades 102 to form at least one score line on each of the dough pieces 14. The conveyor 16 is configured to convey the dough pieces 14 to the second scoring apparatus 20 for scoring and away from the second scoring apparatus 20 after the scoring is completed. The scoring device 10 can be programmed to selectively use the first or the second scoring apparatus to add score lines to the dough pieces 14.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A device for scoring a series of dough pieces, arranged on a support surface, with at least one score line, the device comprising:
a conveyor for conveying the dough pieces in a longitudinal direction;
a first scoring apparatus configured for scoring the dough pieces, the first scoring apparatus having a series of scoring blades;
a first actuator configured for moving the scoring blades in a first direction from a first position to a second position;
a second actuator configured for moving the scoring blades in a second direction that is different from the first direction, wherein movement of the scoring blades in the second direction causes the scoring blades to form at least one score line on each of the dough pieces;
wherein the conveyor is configured to convey the dough pieces to the first scoring apparatus for scoring and away from the first scoring apparatus after the scoring is completed.

2. The device of claim 1, further including a blade wiper configured to assist in wiping the blades after the scoring blades score the dough pieces.

3. The device of claim 2, wherein the blade wiper is in the form of a plate formed to include a series of slits, wherein the blades are configured to move within the slits.

4. The device of claim 1, wherein the device uses the conveyor to convey and align the dough pieces with the scoring blades.

5. The device of claim 1, wherein the second actuator is configured to move the scoring blades in a direction that is diagonal to the longitudinal direction of the conveyor.

6. The device of claim 1, wherein the second actuator is configured to move the scoring blades in a direction that is perpendicular to the longitudinal direction of the conveyor.

7. The device of claim 1, wherein the scoring blades are generally arranged in a row and spaced apart from each other and are configured to move in unison when moved by the second actuator to score the dough pieces.

8. The device of claim 1, wherein the scoring blades are used to apply multiple score lines on the dough pieces.

9. The device of claim 1, further including a second scoring apparatus positioned downstream from the first scoring apparatus, the second scoring apparatus configured for scoring the dough pieces, the second scoring apparatus having a second series of scoring blades;
the second scoring apparatus includes a first actuator configured for moving the second series of scoring blades in a first direction from a first position to a second position;
the second scoring apparatus includes a second actuator configured for moving the second series of scoring blades in a second direction that is different from the first direction, wherein movement of the second series of scoring blades in the second direction causes the second series of scoring blades to form at least one score line on each of the dough pieces;
wherein the conveyor is configured to convey the dough pieces to the second scoring apparatus for scoring and away from the second scoring apparatus after the scoring is completed.

10. The device of claim 9, where in the device can selectively use the first or the second scoring apparatus to add score lines to the dough pieces.

11. A device for scoring a series of dough pieces, arranged on a support surface, with at least one score line, the device comprising:
a first scoring apparatus configured for scoring the dough pieces, the first scoring apparatus having a series of scoring blades;
a first actuator configured for moving the scoring blades in a first direction from a first position to a second position;
a second actuator configured for moving the scoring blades in a second direction that is different from the first direction, wherein movement of the scoring blades in the second direction causes the scoring blades to form at least one score line on each of the dough pieces.

12. The device of claim 11, further including a blade wiper configured to assist in wiping the blades after the scoring blades score the dough pieces.

13. The device of claim 12, wherein the blade wiper is in the form of a plate formed to include a series of slits, wherein the blades are configured to move within the slits.

14. The device of claim 11, wherein the dough pieces are aligned with the scoring blades before being scored.

15. The device of claim 11, wherein the second actuator is configured to move the scoring blades in a diagonal direction.

16. The device of claim 11, wherein the second actuator is configured to move the scoring blades in a perpendicular direction.

17. The device of claim 11, wherein the scoring blades are generally arranged in a row and spaced apart from each other and are configured to move in unison when moved by the second actuator to score the dough pieces.

18. The device of claim 11, wherein the scoring blades are used to apply multiple score lines on the dough pieces.

19. A device for scoring a series of dough pieces, arranged on a support surface, with at least one score line, the device comprising:
a conveyor for conveying the dough pieces in a longitudinal direction;
a first scoring apparatus configured for scoring the dough pieces, the first scoring apparatus having a first series of scoring blades;
a first actuator configured for moving the first series of scoring blades in a first direction from a first position to a second position;
a second actuator configured for moving the first series of scoring blades in a second direction that is different from the first direction, wherein movement of the first series of scoring blades in the second direction causes the first series of scoring blades to form at least one score line on each of the dough pieces;
wherein the conveyor is configured to convey the dough pieces to the first scoring apparatus for scoring and away from the first scoring apparatus after the scoring is completed;
a second scoring apparatus positioned downstream from the first scoring apparatus, the second scoring apparatus configured for scoring the dough pieces, the second scoring apparatus having a second series of scoring blades;
the second scoring apparatus includes a first actuator configured for moving the second series of scoring blades in a first direction from a first position to a second position;
the second scoring apparatus includes a second actuator configured for moving the second series of scoring blades in a second direction that is different from the first direction, wherein movement of the second series of scoring blades in the second direction causes the second series of scoring blades to form at least one score line on each of the dough pieces;
wherein the conveyor is configured to convey the dough pieces to the second scoring apparatus for scoring and away from the second scoring apparatus after the scoring is completed.

20. The device of claim 19, further including a blade wipers configured to assist in wiping the first and second series of scoring blades after the first and second series scoring blades score the dough pieces.
